(19) United States
(12) Patent Application Publication
(10) Pub. No.: US 2024/0204565 A1
(43) Pub. Date: Jun. 20, 2024

(54) PLUG-IN MODULE ASSEMBLY FOR WIRELESS ELECTRIC CHARGING

(71) Applicant: VETUREX INC, Al Safouh 2,, Dubai (AE)

(72) Inventors: Cengiz Hakan KUTLUHAN, Erlangen (DE); Omer Faruk YERLI, Frankfurt am Main (DE)

(21) Appl. No.: 18/067,645

(22) Filed: Dec. 16, 2022

(51) Int. Cl. H02J 50/00; B60L 53/122; H01F 27/28; H02J 7/02; H02J 7/34; H02J 50/10; H02J 50/60; H02M 1/42; H02M 3/335

(52) U.S. Cl. CPC H02J 50/005; B60L 53/122; H01F 27/2823; H01F 27/2885; H02J 7/02; H02J 7/342; H02J 50/10; H02J 50/60; H02M 1/4233; H02M 3/33573; B60L 2210/30; H02J 2207/20

(57) ABSTRACT

A plug-in module for wireless charging a battery of an electronic device includes a chassis, a pad element connected to the chassis for the wireless transference of electromagnetic energy, and an electrical connector connected to the chassis opposite from the pad element. The pad element includes a wire coil of wire windings having an outer diameter and a non-zero inner diameter, an arrangement of ferrite bars including a plurality of individual ferrite bars positioned adjacent to the wire coil, and a metallic shielding frame that houses the wire coil and the arrangement of ferrite bars. The plug-in module may be incorporated into a wireless charging system for wireless transfer of electromagnetic energy for the charging of a battery of an electronic device, such as for example an electric vehicle. Circuitry of the system may include an AC/DC converter with integrated power factor correction, and a high frequency inverter for generating a kHz order electrical input to the wire coil.

### FIELD OF INVENTION

The present application relates to wireless charging of electronic devices. For example, the present application principally is directed toward wireless charging of electric vehicles, although comparable principles may be applied to wireless charging of various types of electronic devices. The wireless charging principles of the present application particularly are suited to charging from a first electric vehicle to a second electric vehicle positioned bumper to bumper.

### BACKGROUND OF THE INVENTION

The battery charging of an electronic device, while seeming simple at first consideration, often is not actually just a matter of plugging the electronic device into a power supply. The electronic device being charged and the power supply or charging point device need to be able to electrically communicate. There can be both operational and physical impediments to such communication. First, the electronic device being charged and the charging device need to communicate through a compatible language pertaining to operational protocols, such as available charging modes and/or electric power compatibility as to parameters such as operational voltage and current levels. In addition, there often has to be a physical connection between the electronic device being charged and the charging device via a charging cable. Different manufactures, however, may employ different configurations of the physical electrical connector components, which may preclude charging an electronic device using a charging device made by a different manufacturer. Physical electrical connector configurations also can vary across international regions.

Compatibility issues in particular remain an issue in connection with the charging of the batteries of electric vehicles (EVs). The charging mode basically determines how quickly the vehicle battery can be charged depending upon the capabilities of the charging point device or charging station. When it comes to the charging cable for operating the various charging modes, there are numerous different connector types, which can differ depending upon the particular vehicle manufacturer, the geographic region, and/or whether one is using a commercial charging point or charging station versus a home domestic electric power supply. Four types of electric charging connectors are common for EVs, including two types common for AC charging (Types 1 and 2) and two types common for DC charging (CHAdeMo and CCS). Type 1 is common for U.S. vehicles and includes a single-phase plug that can charge at a speed of up to 7.4 KW. Type 2 is standard for European and Asian vehicles from 2018 onwards and includes a triple-phase plug that can charge at a level of up to 43 KW. CCS is a version of Type 2 with two additional power contacts that allows for very fast charging. CHAdeMO can be found in Asian cars and allows for high charging capacities as well as bidirectional charging between two devices, for example charging a first EV using power from the battery of a second EV. It is rare to find all four charging connector types in the same charging station unit, and/or in the same EV.

While the popularity of EVs is growing and standardization of connector types is improving, the physical connection between an EV and the charging point or charging station is still a major disadvantage to owning an EV. Comparable physical compatibility issues may arise in various other fields of electronic devices. For example, portable electronic communication and computer devices (e.g., smart phones, tablets, laptops, and the like) are known to have charging equipment that differs from one manufacturer to another manufacturer. One manner of overcoming the compatibility issues associated with physical electrical connectors is to employ wireless charging whereby electromagnetic energy is transmitted across an air gap from the charging device to the device being charged, and the device being charged converts the received electromagnetic energy into a usable form of electrical energy for charging the battery. Although wireless charging systems are being developed, such systems continue to have deficiencies, and in particular a suitable wireless charging system for EVs has been difficult to achieve.

### SUMMARY OF INVENTION

There is a need in the art, therefore, for an improved system for wireless, contactless charging for electronic devices, and that is suitable for electric vehicles (EVs) in particular. Embodiments of the present application provide a plug-in module to be utilized for wireless, contactless charging of the battery in an electronic device. While the present application principally is described in connection with the practical usage particularly in wireless, contactless charging of EVs, the present application is not limited to any particular electric charging application and comparable principles may be applied to wireless, contactless charging of a variety of electronic devices. Suitable examples may include, without limitation, wireless charging of electronic devices used in domestic, engineering, industrial, communications, medical, and military environments, and others.

The plug-in module of the present application particularly is suited to charging from a first electric vehicle to a second electric vehicle, with the first electric vehicle having a first plug-in module and the second electric vehicle having a second plug-in module and the plug-in modules face each other when the two vehicles are positioned adjacent to each other, such as the vehicles being positioned bumper to bumper. Such a system thereby permits urgent charging in a peer-to-peer vehicle transfer of energy between opposing plug-in modules respectively positioned on each of the two vehicles. The wireless energy transfer provides a universal charging protocol that supplements standard charging systems when physical connections may be incompatible.

Embodiments of the present application include a plug-in module that is configured to be connected to a charging socket of an electronic device to be charged. The plug-in module is configured to perform wireless charging. A complementary plug-in module then may be connected to the electric connector of a power supply device, whereby the power supply device may be a charging unit or a charging station such that wireless charging can occur from the power supply device to the electronic device being charged. The power supply device also may be a second electronic device, whereby the plug-in module is capable of bi-directional charging such that a first electronic device at times is the device being charged and a second electronic device acts as the power supply, and at other times vice versa. Because the plug-in module is configured to be plugged into the charging socket of the electronic device being charged, the plug-in module allows for wireless charging of the battery of the electronic device even if the electronic device natively is not configured for wireless charging.

The plug-in module includes a pad element that is configured to receive the electromagnetic energy into the electronic device that is delivered either from a power supply directly which has a complementary pad element for transmitting the electromagnetic energy, or from a second electronic device that also has a battery unit with sufficient charge available for charging the electronic device and having a complementary pad element for transmitting the electromagnetic energy. The plug-in module can be configured as an exterior or separate structure from the electronic device that can be provided as an add-on component to an existing electronic device.

The pad element of the plug-in module includes a wire coil for the receipt of electromagnetic energy by wireless transmission. The electromagnetic energy originates on a primary side such that electromagnetic magnetic energy is generated at a primary side pad element wire coil. The electromagnetic magnetic energy from the primary side pad element wire coil is then transferred to a secondary side pad element, specifically through a secondary side pad element wire coil. The secondary side electronic device converts the electromagnetic magnetic energy into a form suitable for charging the battery of the secondary side electronic device. The primary side and secondary side wire coils are mutually coupled to each other through the flux generated across the air gap between the two pad elements. The secondary side pad element that contains the secondary side wire coil may be a component of a plug-in module that is connected to a charging socket of an electronic device to be charged, such as for example the charging socket for an EV. In one exemplary embodiment pertaining to EV charging, the primary side pad element may be connected to the charging port of an EV charging point or EV charging station. In another exemplary embodiment pertaining to EV charging, bi-directional charging is implemented, whereby the primary side pad element may be connected to the charging socket of a second EV, and the battery power of the second EV is used for wireless charging of the battery of the first EV on the secondary side.

In exemplary embodiments, the wire coil of the pad element is configured as circular wire windings having an outer diameter and a non-zero inner diameter. The wire coil may be configured or shaped as an Archimedean spiral coil. For efficient wireless coupling that is suitable for EV wireless charging, the wire coil may have an outer diameter from 28-32 cm and an inner diameter from 9.0-14.0 cm. Electromagnetic coupling is preferably enhanced by having primary and secondary side wire coils of the same outer diameter and inner diameter dimensions. For wireless EV charging, efficient charging can occur when wire coils with such a configuration are positioned with an air gap or spacing of up to about 10-25 cm between the primary side and secondary side pad elements.

The pad element further includes an arrangement of a plurality of ferrite bars that is positioned against the wire coil in a wheel-and-spoke pattern in which the wire coil forms the wheel of the wheel-and-spoke pattern and the arrangement of ferrite bars forms the spokes of the wheel-and-spoke pattern. In one suitable embodiment for efficient EV charging, the plurality of ferrite bars is arranged in the wheel-and-spoke pattern with an angle of separation of axes of adjacent ferrite bars being 40°, resulting in nine ferrite bars in such wheel-and-spoke configuration. The plurality of ferrite bars may be housed in a metallic shielding frame that further receives and houses the wire coil, which provides for magnetic shielding to limit unwanted electromagnetic radiation transmission into the broader environment. Magnetic shielding is achieved in a high amount when the metallic shielding frame is made of, for example, aluminum or cobalt.

The wire coil, arrangement of ferrite bars, and shielding frame may be incorporated as components of a pad element of a plug-in module for wireless charging. The plug-in module in turn may be incorporated into a wireless charging system for wireless and contactless transfer of electromagnetic energy for the charging of a battery of an electronic device in the system. On the primary side of the system, electric power initially is supplied by a utility grid AC supply. The AC grid supply is converted to a DC source for typical power usage by an AC/DC converter, which for the wireless charging of the current application is configured with an integrated power factor correction stage such that the power factor correction stage and the AC/DC conversion are integrated into a single stage. Through a compensation network including a high frequency inverter, a high-frequency voltage generates energy in the form of a high-frequency current by the primary side plug-in module. The electromagnetic energy is then wirelessly transmitted across an air gap to a secondary side plug-in module including a secondary side compensation network and secondary side wire coil, whereby the secondary side wire coil is mutually coupled to the primary side wire coil via the flux generated by the primary side wire coil. The electromagnetic energy received on the secondary side is rectified by a full-wave rectifier that is connected to the battery of the device being charged, which thereby permits charging the battery.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a drawing depicting an exemplary plug-in module for wireless charging in accordance with embodiments of the present application.

FIG. 2 is a drawing depicting an exemplary electric vehicle for which the plug-in module may be used for wireless charging of the battery of the electric vehicle.

FIG. 3 is a drawing depicting an exemplary wire coil for use in the pad element of the plug-in module of FIG. 1.

FIG. 4 is a drawing depicting a first coil positioned relative to a second coil as depicted in FIG. 3 for wireless charging.

FIG. 5 is a drawing depicting the wire coil of FIGS. 3 and 4 in combination with an arrangement of ferrite bars for enhanced electromagnetic energy transmission.

FIG. 6 is a drawing depicting a simulation setup for illustrating an example positioning of two opposing wire coils with respective ferrite bar arrangements for wireless transmission of electromagnetic energy.

FIG. 7 is a drawing depicting a shielding frame for housing the arrangement of ferrite bars.

FIG. 8 is a drawing depicting the shielding frame housing the arrangement of ferrite bars of FIG. 7, further positioned for housing the wire coil.

FIG. 9 is a drawing depicting an example positioning of two opposing wire coils with respective ferrite bar arrangements and shielding frames for wireless transmission of electromagnetic energy.

FIG. 10 is a drawing depicting an example positioning of two opposing wire coils with respective ferrite bar arrangements, utilizing elliptical shaped wire coils.

FIG. 11 is a drawing depicting an example positioning of two opposing wire coils with respective ferrite bar arrangements, utilizing rectangular shaped wire coils.

FIG. 12 is a drawing depicting a block diagram of an exemplary wireless charging system in accordance with embodiments of the present application.

FIG. 13 is a drawing depicting an exemplary circuit design for an AC/DC converter that includes integrated active power correction to maximize the power factor value for use in the system of FIG. 12.

FIG. 14 is a drawing depicting an exemplary circuit design for isolated bias and drive circuitry for use in combination with the circuit of FIG. 13.

FIG. 15 is a drawing depicting an exemplary circuit design to provide gate drive signals for use in combination with the circuit of FIG. 13.

FIG. 16 is a drawing depicting an exemplary circuit design for a current sensor for use in combination with the circuit of FIG. 13.

FIG. 17 is a drawing depicting an exemplary circuit design for an input voltage sensor for use in combination with the circuit of FIG. 13.

FIG. 18 is a drawing depicting an exemplary circuit design for a DC output voltage sensor for use in combination with the circuit of FIG. 13.

FIG. 19 is a drawing depicting an exemplary circuit design for bias supplies including flyback converters for use in combination with the circuit of FIG. 13, including flyback converters for different voltage levels.

FIG. 20 is a drawing depicting an exemplary circuit design for a controller for use in combination with the circuit of FIG. 13.

FIG. 21 is a drawing depicting an exemplary first circuit design for a high frequency inverter (DC/AC converter) for use in the system of FIG. 12.

FIG. 22 is a drawing depicting an exemplary second circuit design for a high frequency inverter (DC/AC converter) for use in the system of FIG. 12.

FIG. 23 is a drawing depicting an exemplary circuit design for a rectifier (AC/DC converter) for use in the system of FIG. 12.

FIG. 24 is a drawing depicting a peer-to-peer transfer of energy from a first electric vehicle to a second electric vehicle, with each electric vehicle having a plug-in module in accordance with embodiments of the present application.

### DETAILED DESCRIPTION

Embodiments of the present application will now be described with reference to the drawings, wherein like reference numerals are used to refer to like elements throughout. It will be understood that the figures are not necessarily to scale.

FIG. 1 is a drawing depicting an exemplary plug-in module 10 for wireless charging in accordance with embodiments of the present application. The plug-in module 10 includes a pad element 12 for the transference of electromagnetic energy. In exemplary embodiments, the plug-module is capable of bi-directional wireless transmission of electromagnetic energy via the pad element 12, such that the plug-in module 10 can act either as a wireless receiver or a wireless transmitter of electromagnetic energy. Accordingly, in a receiving mode the plug-in module can receive electromagnetic energy for purposes of charging the battery of an electronic device to which the plug-in module 10 is connected, and in a transmitting mode the plug-in module can transmit electromagnetic energy for purposes of supplying electric energy from an electronic device to which the plug-in module 10 is connected.

The pad element 12 is connected to a chassis 14, and the chassis 14 further is connected to an electrical connector 16 positioned oppositely from the pad element 12. The electrical connector 16 is configured to be connected to a charging socket of an electronic device to be charged, and thus the electrical connector 16 may be specifically adapted to have any connector configuration to connect to a corresponding charging socket of the electronic device to be charged. Accordingly, any suitable electrical connector 16 may be connected to the chassis 14, and therefore the plug-in module 10 can be adapted for use with any suitable electronic device simply by using an appropriately configured electrical connector 16. The chassis 14 and electrical connector 16 may be connected to each other via a rotational joint 15 that permits adjustment of the orientation of the pad element 12 to optimize the orientation of the pad element for wireless electromagnetic energy transference.

As further detailed below, the plug-in module particularly is configured to perform wireless charging, and therefore an electronic device may be modified for wireless charging even when the electronic device does not natively permit wireless charging. A complementary plug-in module then may be connected to the electrical connector of a power supply device, whereby the power supply device may be a charging unit or a charging station such that wireless charging can occur from the power supply device to the electronic device being charged. The power supply device alternatively may be a second electronic device, whereby the plug-in module is capable of bi-directional charging such that a first electronic device at times is the device being charged and a second electronic device acts as the power supply, and at other times vice versa. Because the plug-in module 10 is configured to be plugged into the charging socket of the electronic device being charged, the plug-in module allows for wireless charging of the battery of the electronic device even if the electronic device natively is not configured for wireless charging.

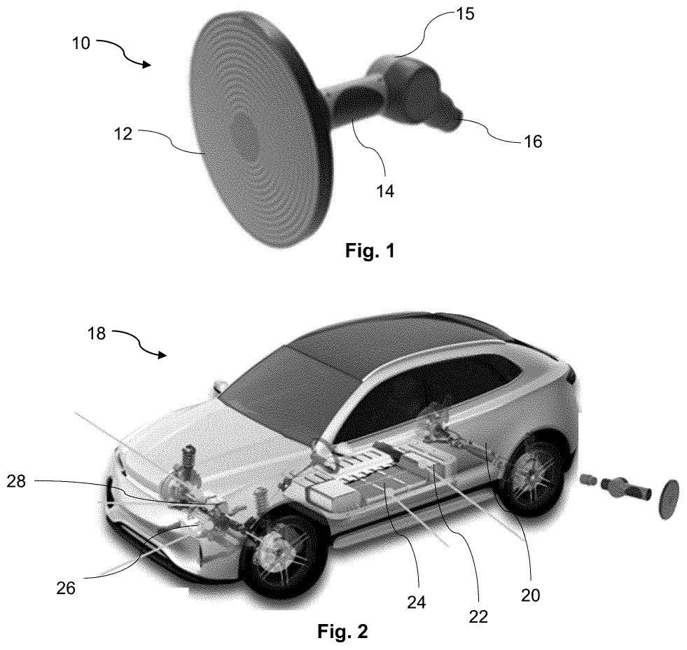

By adapting the electrical connector 16 for a particular application, the plug-in module 10 can be configured as an exterior or separate structure from any suitable existing electronic device to be provided as an add-on component to such existing electronic device for wireless charging. For example, one suitable usage for the plug-in module 10 is for use in charging an electric vehicle (EV). FIG. 2 is a drawing depicting an exemplary electric vehicle 18 for which the plug-in module 10 may be provided as an external or separate add-on component to permit wireless charging of the battery pack of the electric vehicle (EV) 18. The EV 18 has a charging socket 20 that is connected to a charger 22 for performing a charging process that chargers a battery pack 24. The EV 18 further has an electric motor 26 that converts electrical energy from the battery pack 24 into mechanical energy for operating the EV, such as providing traction to the vehicle wheels. The EV 18 further has an inverter 28 for ensuring that the voltage being applied to the motor is at a correct voltage level. FIG. 2 illustrates the plug-in module 10 as located for attachment at the charging socket 20 as an external or separate add-on component. Additional electrical connections or pathways may be provided to connect the plug-in module to the charging socket by locating the plug-in module at any location relative to the EV that is a suitable location for positioning the vehicle in convenient proximity to a charging unit or charging station. For example, additional electrical connections or pathways may be provided to position the plug-in module adjacent to the vehicle hood or front bumper as a convenient location for access to a charging station, or for access a second EV for charging when the vehicles are positioned adjacent to each other. In particular, a hood arrangement permits a bumper-to-bumper positioning of two EVs to position opposing plug-in modules for the wireless transfer of energy from a first EV to a second EV.

The pad element 12 of the plug-in module 10 includes a wire coil for the receipt and transference of electromagnetic energy for charging the electronic device. For wireless charging, electromagnetic energy originates on a primary side such that electromagnetic magnetic energy is generated at a primary side pad element wire coil. The electromagnetic magnetic energy from the primary side pad element wire coil is then transferred to a secondary side pad element, specifically through a secondary side pad element wire coil, and the secondary side electronic device converts the electromagnetic magnetic energy for charging the battery of the secondary side electronic device. The primary side and secondary side wire coils are mutually coupled to each other through the flux generated across the air gap between the two pad elements. The secondary side pad element that contains the secondary side wire coil is the pad element 12 of a plug-in module 10 that is connected to a charging socket of an electronic device to be charged, such as for example the charging socket for an EV. In one exemplary embodiment pertaining to EV charging, the primary side plug-in module 10 may be connected to the charging port of an EV charging point or EV charging station. In another exemplary embodiment pertaining to EV charging, bi-directional charging is implemented, whereby the primary side plug-in module 10 is connected to the charging socket of a second EV, and the battery power of the second EV is used for wireless charging of the first EV on the secondary side via the secondary side plug-in module 10.

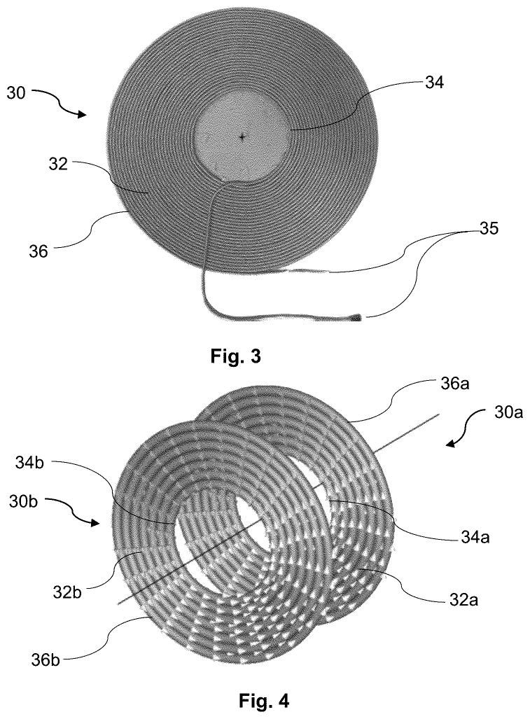

FIG. 3 is a drawing depicting an exemplary wire coil 30 for use in the pad element 12 of the plug-in module 10 of FIG. 1. In exemplary embodiments, the wire coil 30 is configured as circular wire windings 32 having a non-zero inner diameter 34 and an outer diameter 36. The wire coil 30 may be configured or shaped as an Archimedean spiral coil. For efficient wireless coupling that is suitable for EV wireless charging, the wireless coil 30 may have a non-zero inner diameter 34 and an outer diameter 36, and in exemplary embodiments the inner diameter is one third to one half of the outer diameter. In exemplary embodiments, the inner diameter 34 may be from 9.0-14.0 cm, and the outer diameter 36 may be from 28-32 cm. The wire coil 30 may include lead wires 35 for passing current through the wire coil 30. The amount and efficiency of energy transfer via electromagnetic coupling between opposing wire coils depends upon several parameters. It has been found by the inventors that having a larger outer diameter 36 increases the energy transfer capacity across a larger air gap between coils, and the air gap for EV charging typically may range from about 10-25 cm. In addition, as a competing principle relative to energy transfer capacity, losses occur due to electrical resistance within the wire coil, and the electrical resistance increases with the number of wire windings 32. The inventors have found that the more inner windings have less effect on the overall energy transfer capacity, and the number of windings is directly proportional to the electrical resistance of the wire coil. Balancing the factors of sufficient energy transfer capacity versus losses due to electrical resistance, the number of windings is reduced with limited effect on energy transfer capacity by properly dimensioning the non-zero inner diameter 34 relative to the outer diameter 36. The inner and outer diameter ranges indicated above are found by the inventors to be suitable for wireless transfer of electromagnetic energy for EV wireless charging.

As an example material composition of the wire coil 30, H05V-K PVC insulated non-sheathed single core cables with a nominal cross-section of 0.75 mm² may be employed. At an appropriate operating frequency, the increase in wire resistance due to eddy currents must be accounted for, and Litz wire has proven to be effective conductive wiring in minimizing the eddy current effects. As is known in the art, a Litz wire is made up of numerous thin strands that are individually insulated and twisted into a wire cable to guarantee effective utilization of the conductive surface. A suitable configuration of 1500×0.05 mm double silk coated rated Litz wire may be used for the fabrication of the wire coil 30.

FIG. 4 is a drawing depicting a first wire coil 30a positioned relative to a second wire coil 30b for wireless charging. Each of the wire coils 30a and 30b has respective wire windings 32a and 32b. The wire windings of each of the wire coils 30a and 30b is configured to have a respective non-zero inner diameter 34a and 34b, and a respective outer diameter 36a and 36b, within the ranges referenced above, i.e., for example an inner diameter of 9.0-14.0 cm and an outer diameter of 28-32 cm. The first wire coil 30a may be incorporated into a primary side plug-in module connected to a first electronic device for supplying electromagnetic energy to act as a charging device. The second wire coil 30b may be incorporated into a secondary side plug-in module connected to a second electronic device for receiving electromagnetic energy from the primary side plug-in module, which then can be converted for charging the battery of the second electronic device to act as the device being charged. In a system that permits bi-directional charging, the electronic device acting as the primary side charging device and the electronic device acting as the secondary side device being charged can be switched.

The inventors further have found that, as depicted in the example of FIG. 4, electromagnetic coupling is preferably enhanced or most efficient by having primary and secondary side wire coils of the same inner diameter and outer diameter dimensions. For wireless EV charging, efficient charging can occur when wire coils with such a configuration are positioned with an air gap or spacing of about 10-25 cm between the primary side and secondary side pad elements, as is common for EV charging. To illustrate efficacy of the features of the wire coils described in the current application, a wire coil pair was fabricated and tested with each wire coil having an inner diameter of 10.5 cm and an outer diameter of 28.5 cm, resulting in 38 windings per wire coil. The air gap between the coils was set for testing at 10 cm. Different electrical resistances based on wire coil material selections were tested, and the energy transfer also was measured using different input power levels corresponding to distinct loads at frequencies of 60 kHz, 80 KHz, and 100 kHz. The output power level was measured for each combination of input power and coil resistance, and the energy transfer efficiency is calculated as a ratio of the output power to the input power. The results are shown in the table below.

| | | 60 kHz | | 80 kHz | 100 kHz |
|---|---|---|---|---|---|
| 11 Ω | Input Power | 49.51 | W | 32.01 W | 29.59 W |
| | Output Power | 25.66 | W | 18.54 W | 20.03 W |
| | Efficiency | 51.83% | | 57.91% | 67.69% |
| 22 Ω | Input Power | 32.11 | W | 49.04 W | 42.11 W |
| | Output Power | 15.29 | W | 23.96 W | 22.81 W |
| | Efficiency | 47.62% | | 48.86% | 54.17% |
| 44 Ω | Input Power | 26.96 | W | 41.98 W | 38.10 W |
| | Output Power | 9.24 | W | 15.08 W | 17.12 W |

| | | | |
|---|---|---|---|
| Efficiency | 34.26% | 35.93% | 44.92% |

The results in the table above illustrate that sufficient energy transfer efficiency for EV wireless charging is achieved for wire coils configured in accordance with the embodiments of the present application. As referenced above, comparable principles may be applied to wireless, contactless charging of a variety of electronic devices. For any given category of electronic device, the outer and inner diameters of the wire coils may be optimized relative to a typical air gap for a given application to provide the appropriate balance of energy transfer capacity and electrical resistance as may be suitable for such given application.

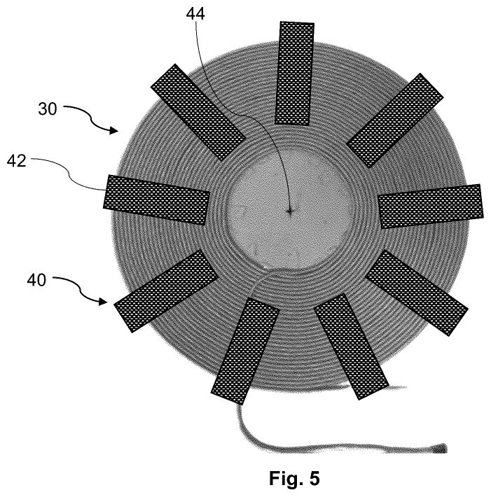

The wireless electromagnetic energy usage is achieved by combining the coils described above with an arrangement of ferromagnetic, or ferrite bars. Once exposed to an external magnetic field, ferromagnetic substances become strongly magnetized. In addition to the extremely strong attraction forces, these solids will become permanently magnetized and the materials can retain their magnetic characteristics even in the absence of external magnetic fields. The use of ferrite bars enhances the wireless electromagnetic energy transfer from the wire coil. FIG. 5 is a drawing depicting the wire coil 30 of FIGS. 3 and 4 in combination with an arrangement of ferrite bars 40. The arrangement of ferrite bars 40 includes a plurality of individual ferrite bars 42. In depicted example, each of the individual ferrite bars 42 is configured as a rectangular bar with a long axis that runs through a center axis 44 of the wire coil 30. Accordingly, the arrangement 40 of the plurality of ferrite bars 42 is positioned against the wire coil 30 in a wheel-and-spoke pattern in which the wire coil 30 forms the wheel of the wheel-and-spoke pattern and individual ferrite bars 42 form the spokes of the wheel-and-spoke pattern. The inventors have found that a particularly suitable wheel-and-spoke arrangement 40 of ferrite bars 42 includes nine ferrite bars 42 each having a long axis at a 40° angle relative to the long axes of adjacent ferrite bars. As examples, nickel-zinc (NiZn) and manganese-zinc (MnZn) are suitable materials for the ferrite bars, and are integrated with the coil 30 to concentrate the magnetic flux and thus increase the transferred power.

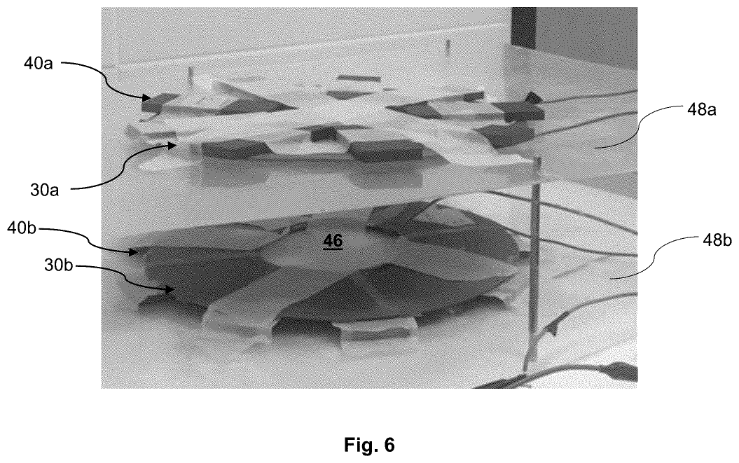

FIG. 6 is a drawing depicting a simulation setup for illustrating an example positioning of two opposing wire coils with respective ferrite bar arrangements for wireless transmission of electromagnetic energy. The example of FIG. 6 illustrates a primary side wire coil 30a opposite a secondary side wire coil 30b. The primary side wire coil 30a is combined with a primary side ferrite bar arrangement 40a, and the secondary side wire coil 30b is combined with a secondary side ferrite bar arrangement 40b. The opposing coils are spaced apart by an air gap 46, which represents an air gap across which wireless energy transmission may occur. For simulation purposes, the primary side wire coil 30a with primary side ferrite bar arrangement 40a is mounted to a primary side support 48a, which in real use may be, for example, a corresponding charging unit or charging station. The secondary side wire coil 30b with secondary side ferrite bar arrangement 40b is mounted to a secondary side support 48b, which in real use may be, for example, a corresponding pad element located within an EV hood, or a pad element of a plug-in module mounted to or connected to an EV body component (e.g., connected to the EV charging socket).

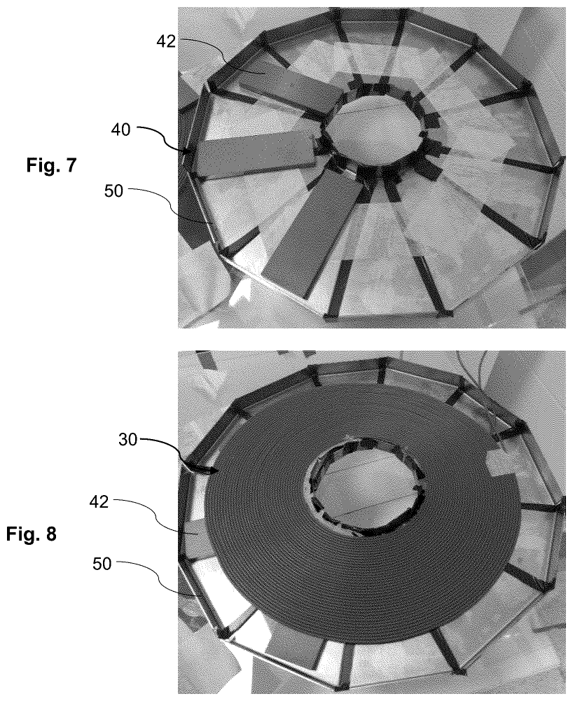

A magnetic field is generated by wireless electromagnetic energy transfer into the surrounding environment. Restrictions on electromagnetic radiation levels are advised by the standards set forth by the International Commission on Non-Ionizing Radiation Protection (ICNIRP). To ensure user safety, all electromagnetic energy couplers must adhere to certain emission restrictions. Accordingly, electromagnetic shielding is a suitable method for reducing the electromagnetic radiation of the wireless electromagnetic energy transfer in the context of the plug-in modules of current application. To achieve the requisite electromagnetic shielding, a shielding frame may be used to mount the ferrite bar arrangement relative to the wire coil, whereby the shielding frame houses the wire coil and the arrangement of ferrite bars. Accordingly, FIG. 7 is a drawing depicting a shielding frame 50 for mounting and housing the arrangement 40 of ferrite bars 42 and the wire coil 30. For better illustration of the shielding frame 50, only a portion of the plurality of individual ferrite bars 42 is illustrated in FIG. 7. In exemplary embodiments, the shielding frame 50 is configured as a metallic shielding frame including a plurality of pie-shaped slices for respective positioning relative to each of the plurality of individual ferrite bars 42.

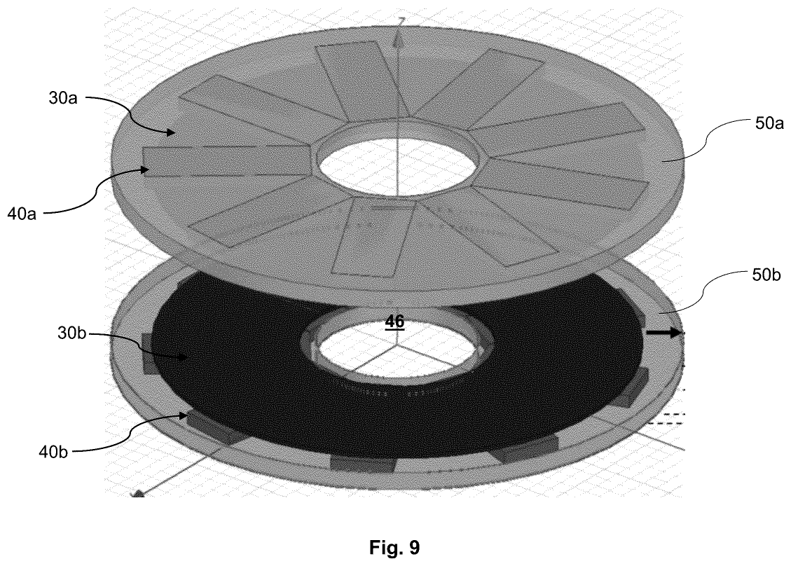

FIG. 8 is a drawing depicting the shielding frame 50 with the arrangement 40 of ferrite bars 42, further positioned relative to the wire coil 30. FIG. 9 is a drawing depicting an example positioning of two opposing wire coils with respective ferrite bar arrangements and shielding frames for wireless transmission of electromagnetic energy. The example of FIG. 9 illustrates a primary side wire coil 30a (shown in shadow) opposite a secondary side wire coil 30b. The primary side wire coil 30a is combined with a primary side ferrite bar arrangement 40a (also shown in shadow) housed in a primary side shielding frame 50a, and the secondary side wire coil 30b is combined with a secondary side ferrite bar arrangement 40b housed in a secondary side shielding frame 50b. The opposing coils again are spaced apart by an air gap 46 which represents a gap across which wireless energy transmission may occur.

For such a configuration of the wire coil with ferrite bar arrangement and a cast iron shielding frame, a coupling coefficient has been measured to be 0.16 when the air gap between opposing wire coils is 15 cm. This is less than the coupling coefficient that is measured when only the ferrite bar arrangement is present without the shielding frame (coupling coefficient measured at 0.18). The reason for the decrement in the coupling coefficient principally is the eddy current loss caused by the electromagnetic shielding. To minimize the eddy current losses, the inventors have optimized parameters of the shielding frame, including the size of the shielding frame (including the outer diameter, height and the thickness of the shielding frame), as well as the materials used for the shielding frame. The inventors have found that increasing the shielding frame height increases resistance and decreases inductance, which decreases the coupling coefficient and directly affects the amount of magnetic field density behind the shielding frame. Increasing the thickness of the shielding frame decreases resistance and inductance, which also decreases the coupling coefficient. Increasing the outer diameter of shielding frame decreases inductance and increases resistance, which also decreases the coupling coefficient. Again, decreasing the coupling coefficient directly affects the amount of magnetic field density behind the shield. Such parameters may be optimized for any suitable application. The inventors further have found that aluminum and cobalt are suitable materials to use for the shielding frame. Cast iron also may be a suitable material for the shielding frame, although aluminum and cobalt may be superior due to lower electrical resistance.

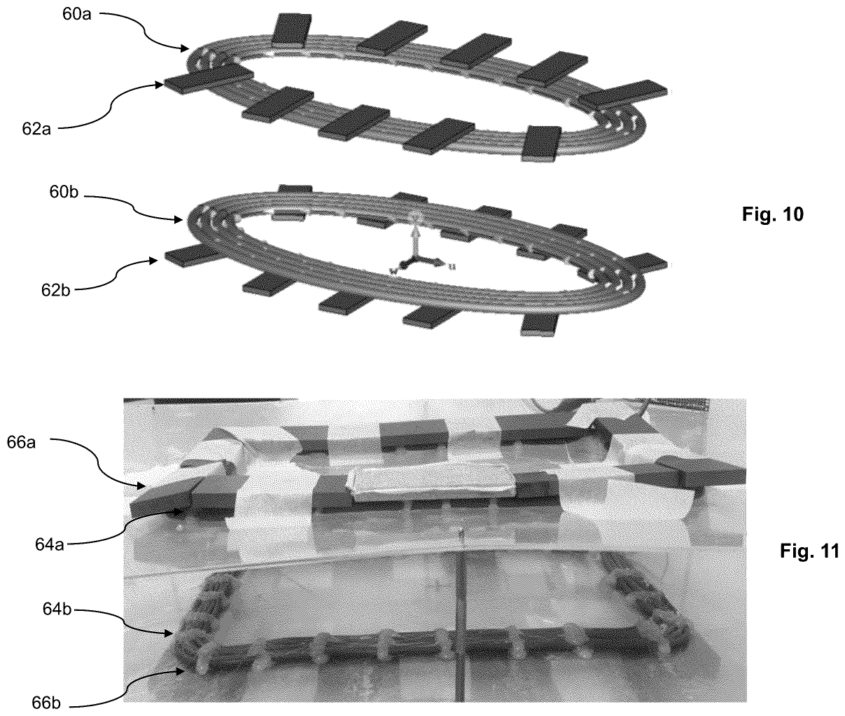

In the above examples, circular wire coils have been employed, which have proven to be effective and easy to manufacture and assemble. Any suitably shaped arrangement may be employed as warranted for any particular application, and therefore embodiments of present application are not limited to any particular shape of wire coil. For example, FIG. 10 is a drawing depicting an example positioning of two opposing wire coils 60a and 60b with respective ferrite bar arrangements 62a and 62b, utilizing elliptical shaped wire coils. As another example, FIG. 11 is a drawing depicting an example positioning of two opposing wire coils 64a and 64b with respective ferrite bar arrangements 66a and 66b, utilizing rectangular shaped wire coils.

Referring back to FIGS. 1 and 2, the embodiments of FIGS. 3-11 may be components of the pad element 12 of the plug-in modules 10. Opposing pad elements then may be used for the wireless transfer of electromagnetic energy between a primary side pad element and a secondary side pad element.

Details of the circuitry for electromagnetic energy transfer and conversion for charging are described in Applicant's previously filed PCT International Appl. No. PCT/EP2021/0587702 filed on Apr. 1, 2021, the contents of which are incorporated here by reference. The circuitry may be incorporated into the chassis component 14 of the plug-in module 10 of the current application. As described in the previously filed PCT application, two different main charging principles can be used, including resonant wireless energy transfer and microwave wireless energy transfer. In the configuration of a magnetically coupled resonance wireless charging method, the amount and direction of the energy flow can be conveniently determined and achieved by matching the interconnected parameters of the magnetically coupled resonance coupling circuits using different topological configurations. The pad element includes an LC resonator configured to receive the electromagnetic energy from a RF source which is tuned with the matching resonance frequency. For example, the resonance frequency may be selected to be between 100 KHz and 13.6 MHz to enhance the energy transfer efficiency. The LC resonator may include serial or parallel configurations of resistor, inductor and capacitor circuits elements. The LC resonator further may include an electronic element with a variable impedance configured for tuning the resonance frequency of the LC resonator. In the configuration of microwave energy transfer, the pad-element may include an antenna array configured to receive electromagnetic energy in the microwave spectrum. Embodiments of the present application further may be capable of bi-directional wireless energy transmission, whereby any electronic device may be operated either as the primary side device that supplies the energy for charging, or the secondary side device that receives the energy for charging and includes the battery to be charged. For such bi-directional wireless transmission capability, the pad element and the circuitry of the chassis may be configured to receive and transmit microwaves by the antenna array. Transmitting the electromagnetic energy by means of microwave energy is particularly useful when a distance between the transmitter and the receiver becomes relatively large.

The plug-in module of the current application may be incorporated into a wireless charging system for wireless and contactless transfer of electromagnetic energy for the charging of a battery of an electronic device in the system. Again, the wireless charging system is described in connection with charging electric vehicles, although comparable principles may be applied to other electronic devices.

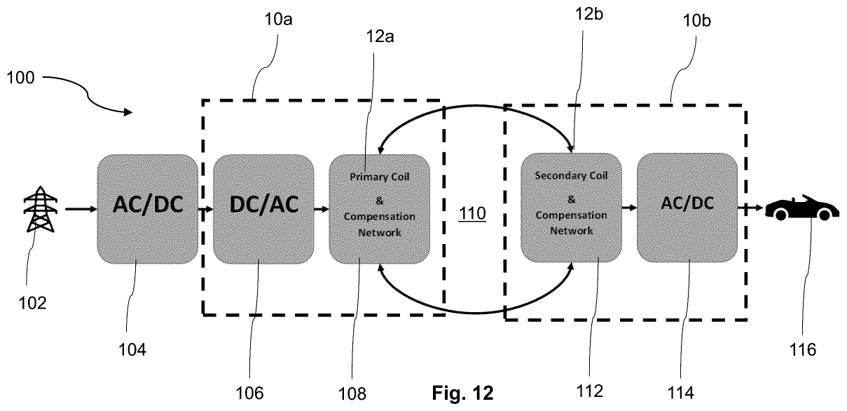

FIG. 12 is a drawing depicting a block diagram of an exemplary wireless charging system 100 in accordance with embodiments of the present application. On the primary side of the system 100, electric power initially is supplied by a utility grid supply 102, which typically is a low frequency 60 Hz AC supply from the community electric grid. The AC grid source is converted to a DC source for typical power usage by an AC/DC converter 104. For wireless energy transfer, thereafter, a higher frequency electric voltage source is required, and thus a high-frequency DC/AC inverter 106 is employed to generate a kHz order electrical input, such as for example a voltage input on the order of a few tens of kHz. Through a compensation network and primary side wire coil 108, this high-frequency voltage generates energy in the form of a high-frequency current. To reduce the VA-rating and therefore the size of the high-frequency inverter 106, the primary compensation network is included to ensure that the primary input voltage and current are in phase. As a result, a nearly sinusoidal current flows into the primary side wire coil, allowing the compensation network supplying to the primary side wire coil to operate in soft switching.

The primary side wire coil component of the compensation network and primary side wire coil 108 may be configured as the pad element 12a described above (the “a” denoting the primary side). Further in this regard, the high-frequency inverter 106 and the compensation network and primary side wire coil 108 may be part of the broader primary side plug-in module 10a (again, the “a” denoting the primary side). The electromagnetic energy is then wireless transmitted across an air gap 110 to a secondary side compensation network and secondary side wire coil 112, whereby the secondary side wire coil is mutually coupled to the primary side wire coil via the flux generated by the primary side wire coil. The secondary side wire coil energy is subsequently processed by the secondary side compensation circuit, which is included to increase the system's power transmission capabilities. Finally, the energy received is rectified by a rectifier 114 configured as an AC/DC converter.

The secondary side wire coil component of the compensation network and secondary side wire coil 112 may be configured as the pad element 12b described above (the “b” denoting the secondary side). Further in this regard, the compensation network and secondary side wire coil 112 and the rectifier 114 may be part of the broader secondary side plug-in module 10b (again, the “b” denoting the secondary side). The secondary side plug-in module 10b in particular may be a plug-in module that is plugged into the charging socket of an EV 116, which thereby permits charging of the EV battery.

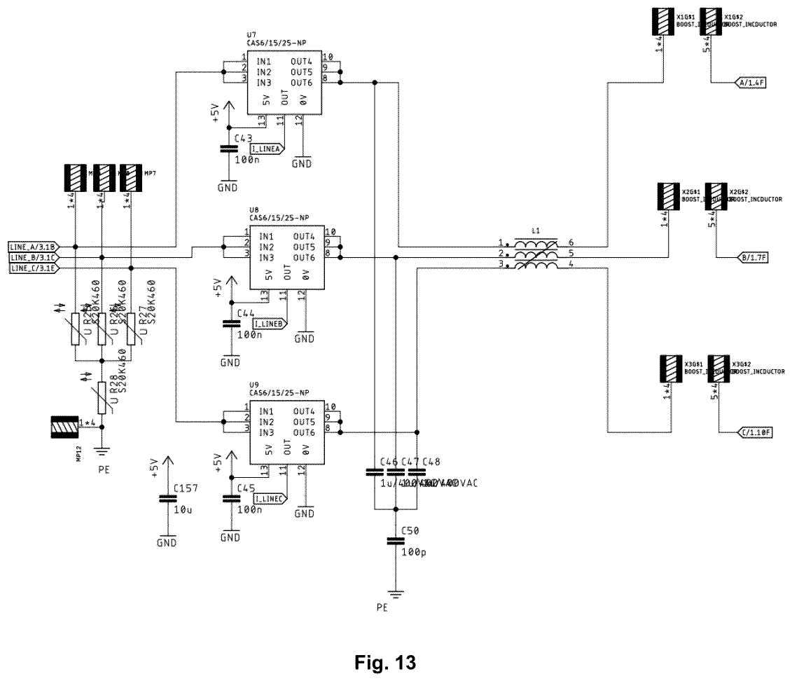

In general, AC/DC converters with high efficiency and power density have been used for a variety of applications. For the wireless charging system 100 of the current application, the AC/DC converter 104 is configured with an integrated power factor correction stage such that the power factor correction stage and the AC/DC conversion are integrated into a single stage. The power factor is understood by those of ordinary skill in the art to be the ratio of real power flowing through the load to the apparent power in a circuit. Real power is the capacity of a circuit to accomplish work at a given moment, whereas apparent power is just the product of voltage and current. If the power factor is low, the current and voltage are not in phase, and thus the point at which voltage and current reach their maximum values undesirably will vary. If the power factor is low, the immediate value of the power will be lower. Accordingly, the power factor value is maximized to minimize power loss and enhance efficiency, and a suitable power factor will have a value ranging from 0 to 1 with one being regarded as the best value. As an example, FIG. 13 is a drawing depicting an exemplary circuit design for an AC/DC converter that includes integrated active power correction to maximize the power factor value. The circuit design depicted in FIG. 13 employs 5.5-kW power factor correction designed to transfer grid power without harmonic pollution. In such diagram, VA, VB, and VC are the AC voltages of a Y connected 3-phase input. Each of these voltages is equal in magnitude and frequency but shifted in-phase by 120°. The evaluation board protects the circuitry against input overcurrent, input inrush current and input overvoltage. The EMI filter is used to suppress both CM noise.

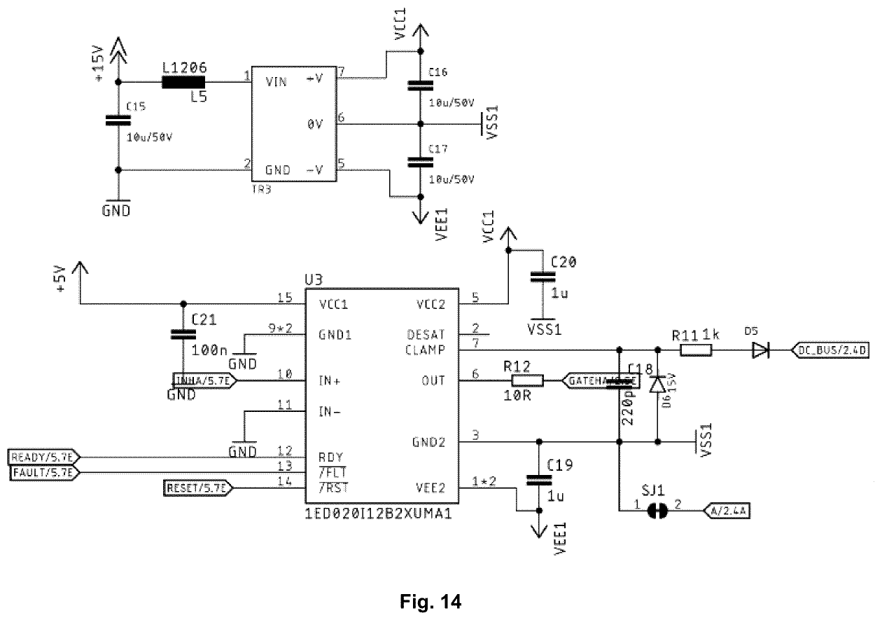

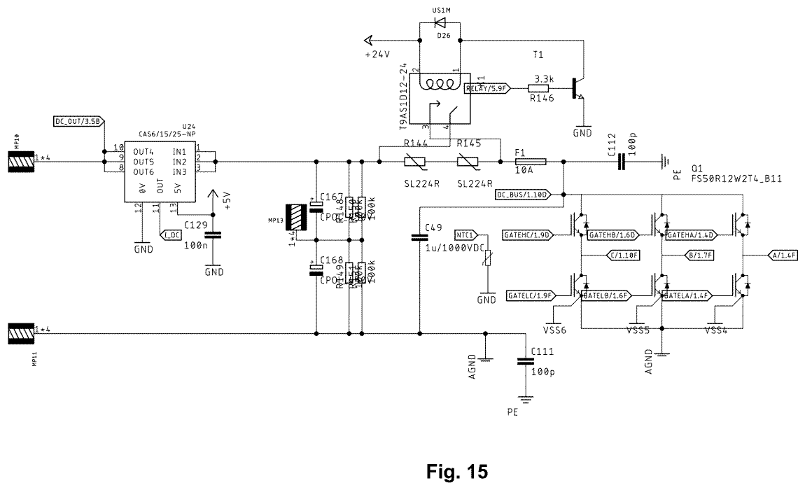

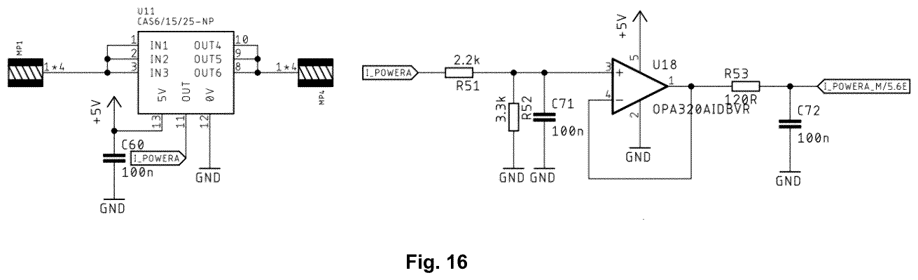

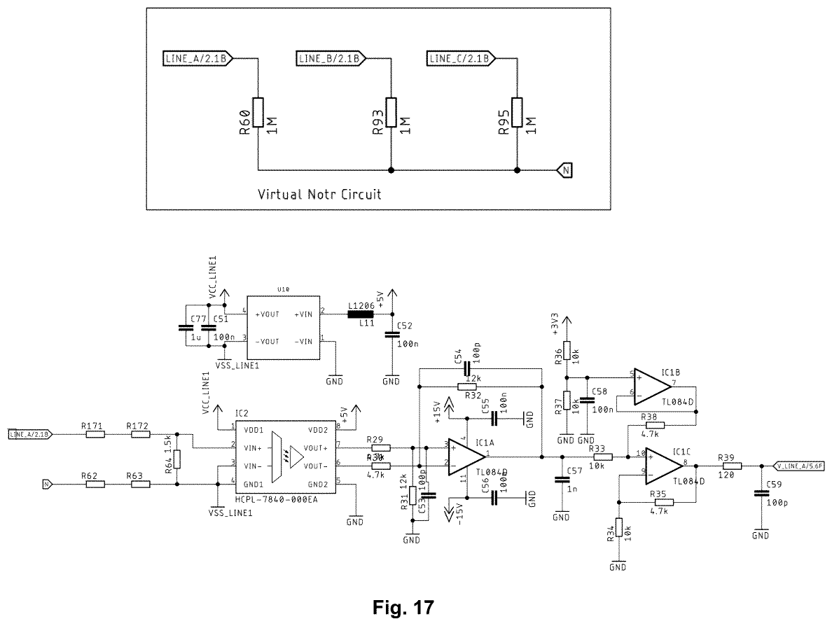

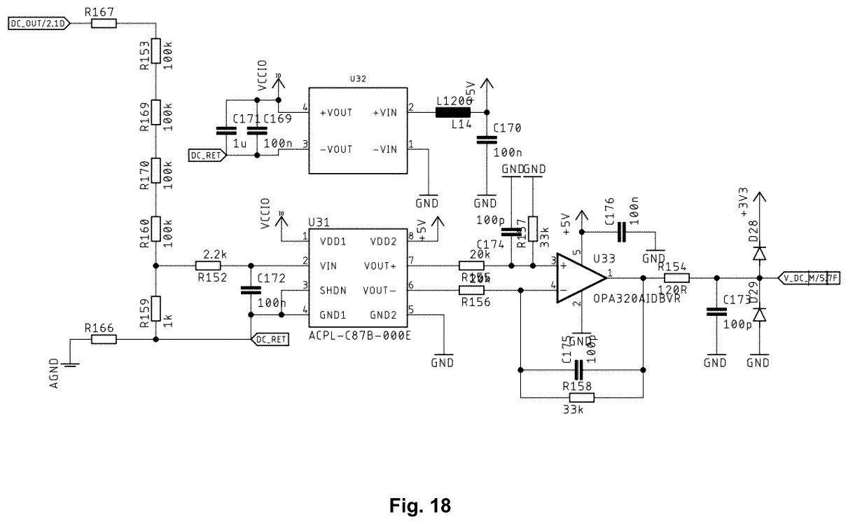

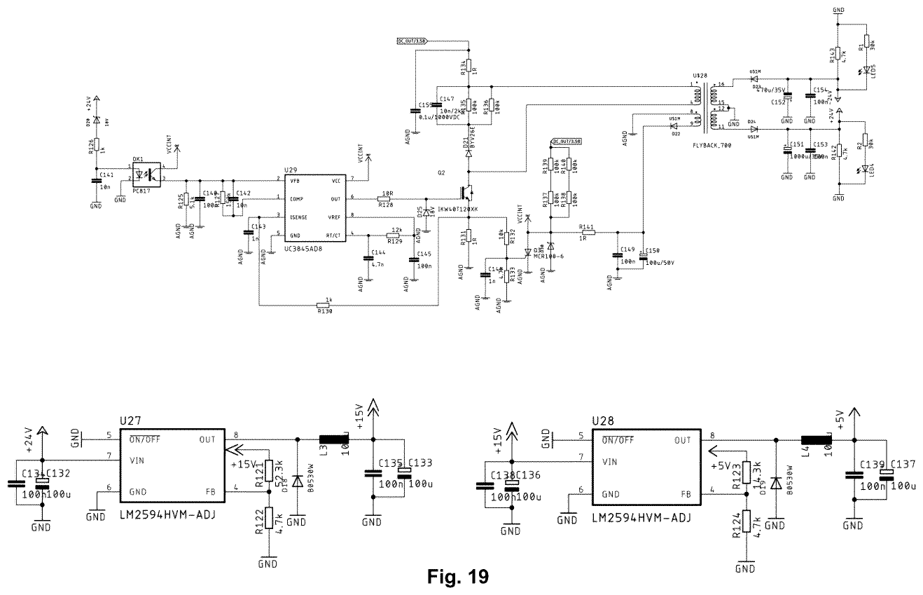

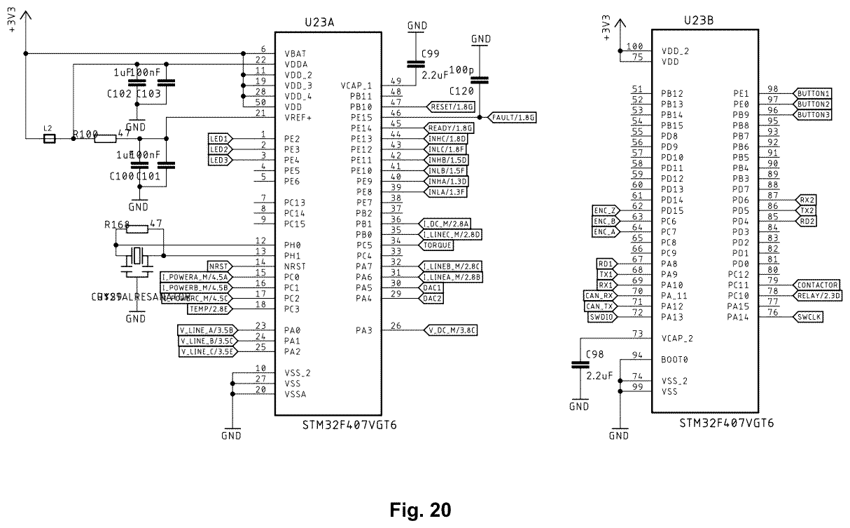

The AC/DC converter with integrated power factor correction further may employ isolated gate bias and drive circuitry. In such configuration, the MOSFETS have been driven with isolated drivers. FIG. 14 is a drawing depicting an exemplary configuration of one of the isolated bias supply circuits used to generate the bipolar supply voltages with respect to isolated ground. A gate drive signal has been propagated across the isolation barrier to the high-voltage side, and the gate drive signal has been connected to the MOSFET, as shown in the circuit depicted in FIG. 15. In addition, the current in each of the three phases is monitored by a current sensor, which is depicted in FIG. 16. The current signal is processed by a pair of operational amplifiers that buffer, level shift and filter the current sensor output. To achieve high power factor and low harmonics, as illustrated in FIG. 17 the AC input current is forced to match the AC input voltage. Isolation amplifiers are used to measure the AC input voltage for all three phases. The voltage is scaled down, isolated, filtered, and then digitized by the analog-to-digital converters (ADCs) in a microcontroller. FIG. 17 shows that each of the three phases have been measured from phase to neutral, using a virtual neutral point. Furthermore, an additional sensing circuit is provided for sensing the DC output voltage, which is illustrated in FIG. 18. FIG. 19 is a drawing depicting an exemplary circuit design for bias supplies including flyback converters for different voltage levels. The evaluation board requires an external+/−24V and +/−15V supply for biasing all the internal components. The circuitry in FIG. 19 depicts the flyback converter which has been designed for the 5.5-kW AC/DC converter with active power factor correction. The flyback converter is a suitable topology because it offers competitive size, cost, and efficiency ratios in the low- to mid-power range. A flyback converter's operation is based on a coupled inductor, which aids in power conversion while isolating the converter's input and output. The coupled inductor also enables multiple outputs, which makes flyback converters the standard for a wide variety of applications. FIG. 20 is a drawing depicting an exemplary circuit design for a controller for use with the AC/DC converter with active power factor correction. The controller design may be based on the high-performance Arm® Cortex®-M4 32-bit RISC core operating at a frequency of up to 168 MHZ, and has been optimized for 3-phase digital control in real-time applications. The controller design offers three 12-bit ADCs, two digital-to-analog converters (DACs), a low-power real-time clock (RTC), twelve general-purpose 16-bit timers including two PWM timers for motor control, and two general-purpose 32-bit timers. Such MCU-based digital control optimizes the converter's overall performance including limiting inrush current, programmable overload protection schemes, and high-power factor of conversion, which gives the device a competitive advantage in high power applications.

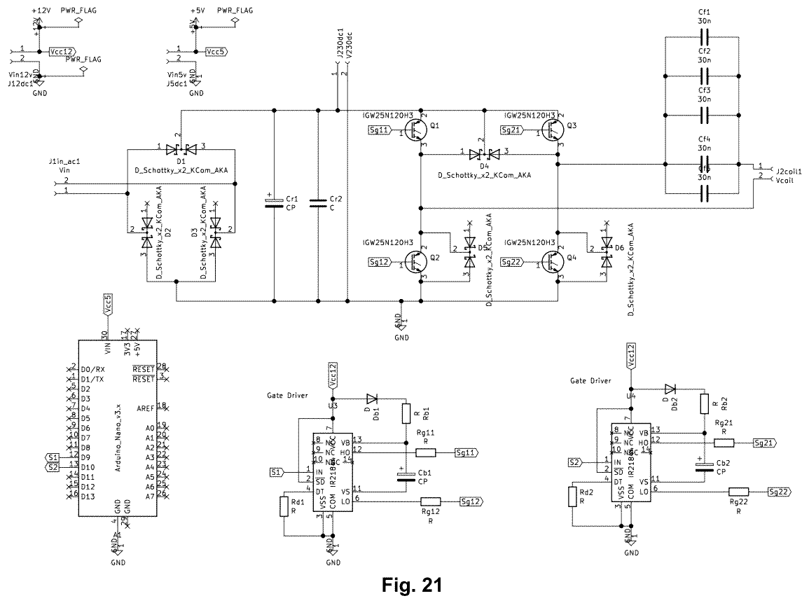

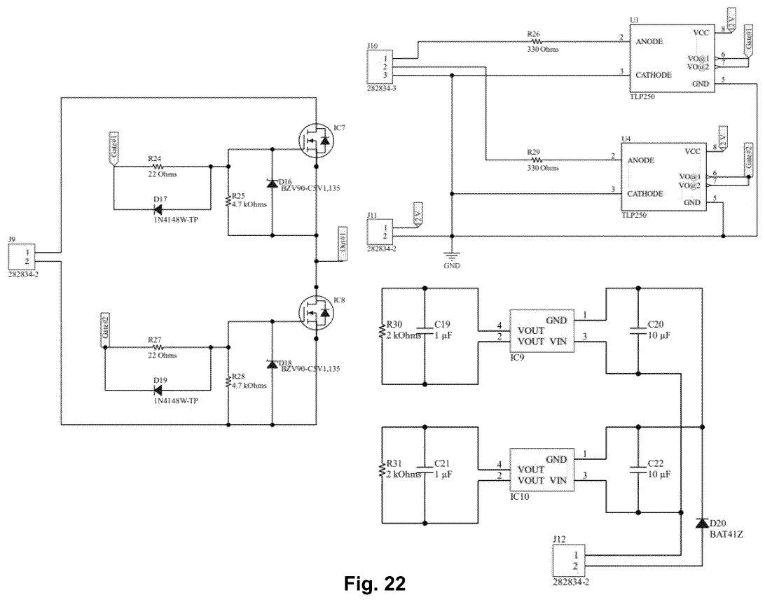

FIG. 21 is a drawing depicting an exemplary first circuit design for the high frequency inverter 106 (DC/AC converter). The high frequency inverter 106 (DC/AC converter) may be configured as a single-phase high frequency inverter, which has been designed to establish an efficient inductive coupling through magnetic fields. For the design depicted in FIG. 21, four IGBTs and four silicon carbide Schottky diodes have been used. To control IGBTs, two half-bridge drivers have been added. To feed these drivers, an Arduino Uno has been included to form a continuous conduction-mode (CCM) boost converter that uses a PFC controller. This circuitry also has a primary side wire coil connection. Polypropylene film capacitors are used for the compensation network due to polypropylene film capacitors having lower equivalent series resistance and higher current carrying capability. FIG. 22 is a drawing depicting an exemplary second circuit design for the high frequency inverter 106 (DC/AC converter). In the example of FIG. 22, two MOSFETs are used for a half-bridge. To control the MOSFETs, two photocouplers are included. To feed these drivers, a DC-DC converter has been added. A Nucleo-F401 has been utilized to form the continuous conduction-mode (CCM) boost converter that uses a PFC controller.

The configuration of the wire coil components of the coil and compensation networks 108 and 112 are described above in connection with FIGS. 3-11.

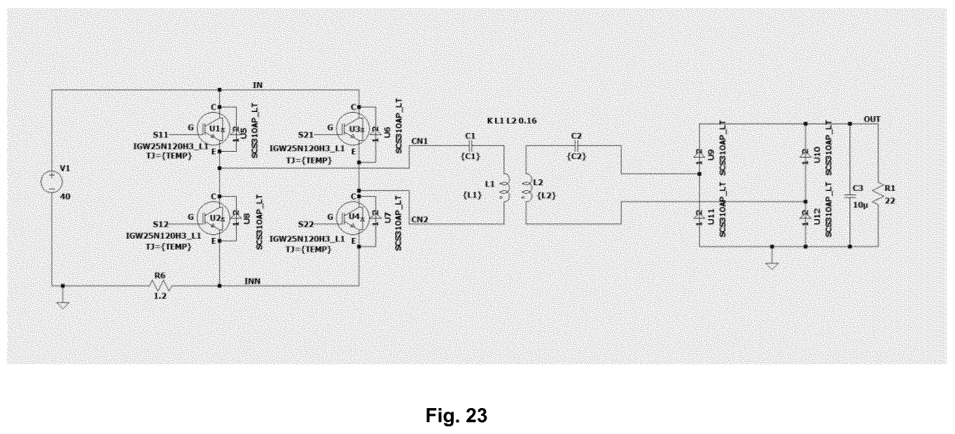

FIG. 23 is a drawing depicting an exemplary circuit design for the rectifier 114 (AC/DC converter). The rectifier 114 may be configured as a full-wave rectifier that includes three silicon carbide Schottky diodes and an aluminum electrolytic capacitor. The rectifier circuitry is inserted between the secondary side compensation network and EV battery.

The plug-in module of the present application particularly is suited to charging from a first EV to a second EV, with the first EV having a first plug-in module and the second EV having a second plug-in module and the plug-in modules face each other when the two vehicles are positioned adjacent to each other, such as the vehicles being positioned bumper to bumper. Such a system thereby permits urgent charging in a peer-to-peer vehicle transfer of energy between opposing plug-in modules respectively positioned on each of the two EVs. The wireless energy transfer provides a universal charging protocol that supplements standard charging systems when physical connections may be incompatible.

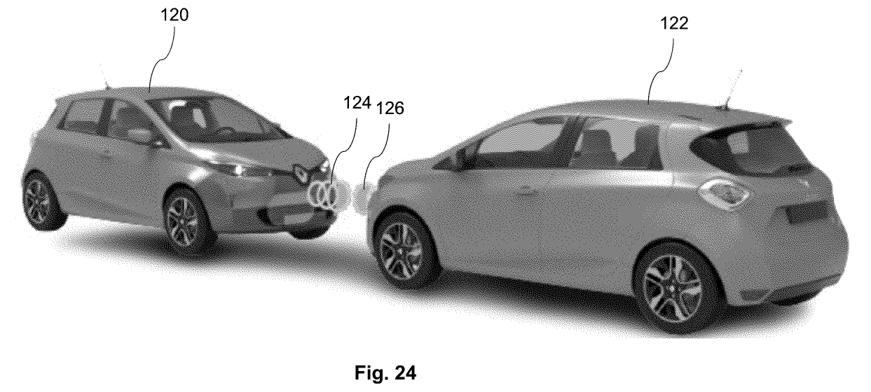

Accordingly, FIG. 24 is a drawing depicting a peer-to-peer transfer of energy from a first EV 120 to a second EV 122, with each vehicle having a plug-in module in accordance with embodiments of the present application. In particular, the first EV 120 has a first plug-in module 124, and the second EV 122 has a second plug-in module 126. In the depicted example of FIG. 24, each of the plug-in modules is positioned with connections to the front or hood of each respective EV, and internal connections would run through the EV for connection to the battery back. A front or hood arrangement provides for convenient positioning of the EVs in a front bumper-to-bumper orientation, although other suitable positions may be employed. For example, rear positioning or side positioning of the plug-in modules may be employed to provide other potential relative EV orientations, such as side-to-side (e.g., if the EVs are in adjacent parking spaces), rear-to-rear bumper if both EVs have a rearward plug-in module positioning, or front bumper to rear bumper if one EV has a front positioned plug-in module and one EV as a rear positioned plug-in module. At times, the first EV 120 may be the power supply device that uses its own battery power to charge the battery of the second EV 122, while at other times, the second EV 122 may be the power supply device that uses its own battery power to charge the battery of the first EV 120.

An aspect of the invention is a plug-in module for wireless charging a battery of an electronic device. In exemplary embodiments, the plug-in module includes a chassis; a pad element connected to the chassis for the wireless transference of electromagnetic energy; and an electrical connector connected to the chassis opposite from the pad element. The pad element includes a wire coil of wire windings having an outer diameter and a non-zero inner diameter; an arrangement of ferrite bars including a plurality of individual ferrite bars positioned adjacent to the wire coil; and a metallic shielding frame that houses the wire coil and the arrangement of ferrite bars. The plug-in module may include one or more of the following features, either individually or in combination.

In an exemplary embodiment of the plug-in module, the inner diameter is one third to one half of the outer diameter.

In an exemplary embodiment of the plug-in module, the inner diameter is from 9.0-14.0 cm and the outer diameter is from 28-32 cm.

In an exemplary embodiment of the plug-in module, the wire windings of the wire coil include non-sheathed single core cables of Litz wire.

In an exemplary embodiment of the plug-in module, the arrangement of ferrite bars is positioned with the plurality of individual ferrite bars positioned against the wire coil in a wheel-and-spoke pattern in which the wire coil forms a wheel and the plurality of individual ferrite bars forms spokes of the wheel-and-spoke pattern.

In an exemplary embodiment of the plug-in module, each of the plurality of individual ferrite bars is a rectangular bar with a long axis that runs through a center axis of the wire coil.

In an exemplary embodiment of the plug-in module, the arrangement of ferrite bars includes nine individual ferrite bars each having a long axis at a 40° angle relative to long axes of adjacent ferrite bars.

In an exemplary embodiment of the plug-in module, each of the plurality of individual ferrite bars includes nickel-zinc or manganese-zinc.

In an exemplary embodiment of the plug-in module, the metallic shielding frame includes a plurality of pie-shaped slices for respective positioning each of the plurality of individual ferrite bars.

In an exemplary embodiment of the plug-in module, the metallic shielding frame includes one or more of aluminum, cobalt, or cast iron.

In an exemplary embodiment of the plug-in module, the wire coil has a circular shape.

In an exemplary embodiment of the plug-in module, the wire coil has an elliptical shape or a rectangular shape.

In an exemplary embodiment of the plug-in module, the plug-in module further includes a rectifier circuit for conversion of the electromagnetic energy received by the wire coil into a form of electrical energy for charging the battery.

Another aspect of the invention is a wireless charging system that includes a first plug-in module that acts as a primary side plug-in module that supplies electromagnetic energy; and a second plug-in module that acts as a secondary side plug-in module that receives the electromagnetic energy from the primary side plug-in module for wireless charging of a battery that is connected to the secondary side plug-in module; wherein each of the first plug-in module and the second plug-in module is configured according to the plug-in module of any of the embodiments. The wireless charging system may include one or more of the following features, either individually or in combination.

In an exemplary embodiment of the wireless charging system, the primary side plug-in module includes a high frequency inverter circuit for generating a kHz order electrical input to the wire coil of the primary side plug-in module.

In an exemplary embodiment of the wireless charging system, the primary side plug-in module includes a compensation circuit that ensures that a primary current input and a primary voltage input from the high frequency inverter are in phase.

In an exemplary embodiment of the wireless charging system, the wireless charging system has a capability for bi-directional charging in which the first plug-in module acts as either the primary side plug-in module or the secondary side plug-in module, and the second plug-in module acts as the other of the primary side plug-in module or the secondary side plug-in module.

In an exemplary embodiment of the wireless charging system, the wireless charging system further includes an AC/DC converter that receives AC electrical power from a grid source and supplies DC electrical power to the primary side plug-in module, wherein the AC/DC converter includes a circuit having an integrated power factor correction stage such that the integrated power factor correction stage and AC/DC conversion are integrated into a single stage.

In an exemplary embodiment of the wireless charging system, the AC/DC converter includes an isolated gate bias and drive circuit in which MOSFETs are driven with isolated drivers.

In an exemplary embodiment of the wireless charging system, the AC/DC converter further includes one or more of a current sensor circuit, a voltage sensor circuit, and a DC output voltage sensor circuit.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A plug-in module for wireless charging a battery of an electronic device, the plug-in module comprising:
a chassis;
a pad element connected to the chassis for the wireless transference of electromagnetic energy; and
an electrical connector connected to the chassis opposite from the pad element;
the pad element comprising:
a wire coil of wire windings having an outer diameter and a non-zero inner diameter;
an arrangement of ferrite bars including a plurality of individual ferrite bars positioned adjacent to the wire coil; and
a metallic shielding frame that houses the wire coil and the arrangement of ferrite bars.

2. The plug-in module of claim 1, wherein the inner diameter is one third to one half of the outer diameter.

3. The plug-in module of claim 1, wherein the inner diameter is from 9.0-14.0 cm and the outer diameter is from 28-32 cm.

4. The plug-in module of claim 1, wherein the wire windings of the wire coil include non-sheathed single core cables of Litz wire.

5. The plug-in module of claim 1, wherein the arrangement of ferrite bars is positioned with the plurality of individual ferrite bars positioned against the wire coil in a wheel-and-spoke pattern in which the wire coil forms a wheel and the plurality of individual ferrite bars forms spokes of the wheel-and-spoke pattern.

6. The plug-in module of claim 5, wherein each of the plurality of individual ferrite bars is a rectangular bar with a long axis that runs through a center axis of the wire coil.

7. The plug-in module of claim 6, wherein the arrangement of ferrite bars includes nine individual ferrite bars each having a long axis at a 40° angle relative to long axes of adjacent ferrite bars.

8. The plug-in module of claim 1, wherein each of the plurality of individual ferrite bars includes nickel-zinc or manganese-zinc.

9. The plug-in module of claim 1, wherein the metallic shielding frame includes a plurality of pie-shaped slices for respective positioning each of the plurality of individual ferrite bars.

10. The plug-in module of claim 1, wherein the metallic shielding frame includes one or more of aluminum, cobalt, or cast iron.

11. The plug-in module of claim 1, wherein the wire coil has a circular shape.

12. The plug-in module of claim 1, wherein the wire coil has an elliptical shape or a rectangular shape.

13. The plug-in module of claim 1, further comprising a rectifier circuit for conversion of the electromagnetic energy received by the wire coil into a form of electrical energy for charging the battery.

14. A wireless charging system comprising:
a first plug-in module that acts as a primary side plug-in module that supplies electromagnetic energy; and
a second plug-in module that acts as a secondary side plug-in module that receives the electromagnetic energy from the primary side plug-in module for wireless charging of a battery that is connected to the secondary side plug-in module;
wherein each of the first plug-in module and the second plug-in module is configured according to the plug-in module of claim 1.

15. The wireless charging system of claim 14, wherein the primary side plug-in module includes a high frequency inverter circuit for generating a kHz order electrical input to the wire coil of the primary side plug-in module.

16. The wireless charging system of claim 15, wherein the primary side plug-in module includes a compensation circuit that ensures that a primary current input and a primary voltage input from the high frequency inverter are in phase.

17. The wireless charging system of claim 14, wherein the wireless charging system has a capability for bi-directional charging in which the first plug-in module acts as either the primary side plug-in module or the secondary side plug-in module, and the second plug-in module acts as the other of the primary side plug-in module or the secondary side plug-in module.

18. The wireless charging system of claim 14, further comprising an AC/DC converter that receives AC electrical power from a grid source and supplies DC electrical power to the primary side plug-in module, wherein the AC/DC converter includes a circuit having an integrated power factor correction stage such that the integrated power factor correction stage and AC/DC conversion are integrated into a single stage.

19. The wireless charging system of claim 18, wherein the AC/DC converter includes an isolated gate bias and drive circuit in which MOSFETs are driven with isolated drivers.

20. The wireless charging system of any of claim 18, wherein the AC/DC converter further includes one or more of a current sensor circuit, a voltage sensor circuit, and a DC output voltage sensor circuit.
